(19) United States
(12) Patent Application Publication
(10) Pub. No.: US 2017/0114247 A1
(43) Pub. Date: Apr. 27, 2017

(54) PROCESSES FOR MOISTURE SCAVENGING IN PREPARING POLYURETHANE COATINGS AND COMPOSITIONS THEREFOR

(71) Applicant: Achiewell, LLC, North Wales, PA (US)

(72) Inventors: Jose Miguel Lorenzo, Allentown, PA (US); Jason Lucas Chou, Blue Bell, PA (US)

(21) Appl. No.: 15/295,089

(22) Filed: Oct. 17, 2016

Related U.S. Application Data
(60) Provisional application No. 62/285,270, filed on Oct. 24, 2015.

(51) Int. Cl. C09D 175/04; B05D 3/00

(52) U.S. Cl. CPC C09D 175/04; B05D 3/007; C08K 5/5419

(57) ABSTRACT

Methoxyorganosilicon compounds having an electron withdrawing group on the silicon atom in combination with tertiary methylamine catalysts having hydrophobic substituents can effectively, even at ambient temperatures, reduce water content in polyurethane coating compositions by catalytic transalkylation to produce methanol and a hydroxy group on the silicone compound without unduly adversely affecting the polyurethane coating.

### FIELD OF THE INVENTION

This application is a continuation of provisional patent application Ser. No. 62/285,270 filed Oct. 24, 2015 which is incorporated by reference as fully set forth herein.

### BACKGROUND

This invention pertains to moisture scavenging in polyurethane coating compositions and to compositions therefor. Polyurethane coatings are conventionally prepared by the reaction of a compound having two or more hydroxyl functional groups (herein referred to as a polyol) with a compound containing two or more isocyanate moieties (herein referred to as a polyisocyanate). These coatings can be prepared using a two component system by admixing a composition containing the polyol and usually a catalyst for the condensation reaction (herein referred to as Part A) with a composition containing polyisocyanate (herein referred to as Part B). One or more of Part A and Part B can contain other adjuvants such as, but not limited to, chain extenders and cross-linkers, leveling agents, solvents, pigments and dyes, anti-foam agents, and modifiers.

One difficulty that can be encountered in the preparation of a polyurethane coating is the presence of water in the composition which may be introduced with an ingredient for making Part A, or which may be introduced from the environment into Part A or during the mixing of Parts A and B and the application of the mixture to the surface to be coated. Usually, the presence of water adversely affects pot life and viscosity extension. The water can, in some instances, adversely affect the properties of the formed, polyurethane coating.

The concentration of water that can have adverse effects on the polyurethane coating composition and coatings themselves can be relatively small, often less than about 10,000 parts per million by mass based upon the mass of Part A. Effectively removing such a small amount of water to desirable levels, say, below about 1000 parts per million by mass, is therefore challenging. Proposals have included the introduction of molecular sieves into the polyurethane coating composition to capture water. The molecular sieves must remain adequately dispersed in order to effect the water scavenging activity, and also add to discoloration of the polyurethane coating.

Accordingly processes and compositions are sought that scavenge water without unduly adversely affecting the coating process, coating drying, coating appearance or coating performance. Moreover, desirably the processes and compositions are sufficiently robust that variations in water content from the ingredients and from the environment during mixing of Parts A and B and during application and curing of the coating, can be accommodated. Further, it is desired that the water scavenging not require special conditions such as elevated temperature especially at the location of mixing Parts A and B and application of the coating.

### SUMMARY

In accordance with this invention it has been found that certain organosilicon compounds in combination with certain amines can effectively, even at ambient temperatures, reduce water content in compositions to make polyurethane coatings without unduly adversely affecting the polyurethane coating. These organosilicon compounds and amines can advantageously be incorporated into a Part A of a two component polyurethane coating system.

In its broad aspects, this invention pertains to polyol-containing compositions for making polyurethane coatings (Part A) comprising:
a. at least one polyol;
b. at least one organosilicon compound represented by the formula

(R¹)₍₄₋ₙ₎—Si—(OCH₃)ₙ
wherein n is an integer of 1 or 2 or 3 and each R¹ is selected from the group of (i) substituted or unsubstituted aliphatic or aromatic hydrocarbyl of 1 to about 6 carbons wherein the substituents are alkoxy preferably having 1 to 4 carbons, hydroxy and halo, preferably fluoro or chloro and (ii) alkoxy of 1 to 4 carbons with the proviso that at least one R¹ is an electron withdrawing moiety selected from the group consisting of (R²)₍₃₋ₘ₎Xₘ—C—C(H₂)— wherein R² is hydrogen or alkyl of 1 to 4 carbons, X is hydroxyl, fluorine or chlorine and m is an integer of 1, 2 or 3; (R²)₍₂₋ₚ₎Xₚ—C═C(H)— and p is an integer of zero, 1 or 2; and phenyl and substituted phenyl wherein the substituents are alkyl or alkoxy of 1 to 4 carbons, hydroxy and halo, preferably fluoro or chloro; and
c. at least one amine (“selected amine catalyst”) represented by the formula

(H₃C)₂—N—R³ or [(H₃C)₂—N]_{(q)}R⁴or [(H₃C₂—N—C(H₂)—C(H₂)]_{(q)}—R⁵
wherein R³ is alkyl of 3 to 6 carbons which other than the alpha carbon can be substituted or unsubstituted wherein the substituents are aromatic hydrocarbyl; alkoxy, preferably of 1 to 6 carbons; hydroxyl; halo, preferably fluoro or chloro; carboxy; and carbamyl moieties, q is an integer of 1, 2, or 3, and R⁴ is an unsubstituted or substituted hydrocarbyl of 2 to 24 carbons or heteroaliphatic or heteroaromatic, wherein the hetero atom is one or more of oxygen, sulfur, nitrogen, preferably wherein the amine is at least two carbons distant from any electron withdrawing group, and q is an integer from 2 to 6, preferably 2, 3, or 4, preferably R⁴ is an alkane or —(R⁷)_{(q)}—R⁸ wherein R⁷ is alkylene of 1 to 4 carbons and R⁸ is phenyl or alkene; wherein R⁵ is selected from the group of alkylene of 1 to about 8 carbons; —(R⁶)₂—(C(O)); and —(R⁶N(H))₂—(C(O)) wherein R⁶ is hydrogen or an alkylene of 1 to 4 carbons, wherein the mole ratio of the at least one polyol to the at least one organosilicon compound is greater than about 10:1, preferably between about 12:1 to 30:1, and wherein the mole ratio of the at least one organosilicon compound to the at least one amine (selected amine catalyst) is greater than about 1.2:1, preferably between about 2:1 to 20:1.

Without wishing to be limited by theory, it is believed that the electron withdrawing moiety on the silicon atom of the organosilicon compound increases the attraction of the oxygen atom in water to the silicon atom and with a hydrogen atom in the water molecule being attracted to the methoxy group on the silicon atom. This attraction enables a catalyzed reaction using a specific type of amine catalyst to occur whereby methanol is produced leaving a hydroxyl substituent on the silicon atom of the organosilicon compound. The amine catalyst contains at least one tertiary amine having two methyl substituents and a longer alkyl substituent that provides hydrophobicity such that the amine function has steric, hydrophobicity and resonance at the nitrogen atom to effect quickly the catalytic reaction even at ambient temperatures.

Organosilicon compounds without the electron withdrawing moiety such as methyltrimethoxysilane or with higher alkoxy substituents such as vinyltriethoxysilane exhibit substantially less water removal activity, all other things remaining the same, as methoxysilanes with electron withdrawing groups such as phenyltrimethoxysilane and vinyltrimethoxysilane. Similarly, even with an electron withdrawing group, vinyltriethoxysilane exhibits substantially less water removal activity, all other things remaining the same, as methoxysilanes with electron withdrawing groups.

Amine catalysts such trimethylamine proved to be relatively ineffective for water removal, even using organosilicon compounds that have desirable electron withdrawing groups on the silicon atom. Bulkier catalysts such as 1,3-bis[3-dimethylanimo)propyl]urea (UBTA) and 2,4,6-tris[(dimethylamino)methyl]phenol (PBTA) exhibit desirable activity for water removal with such organosilicon compounds.

As can be appreciated, the organosilicon compound and selected amine catalysts used in this invention can be selected to avoid or mitigate discoloration of the polyurethane coating by using components devoid of metals and aromatic moieties, e.g., UBTA can be used rather than PBTA. Hence, certain compositions of this invention can be used to provide clear polyurethane coatings.

Another broad aspect of this invention pertains to processes for reducing the moisture content of polyol-containing compositions. In these processes, a moisture-containing polyol composition is contacted with an organosilicon compound as described above and an amine as described above for a time sufficient to reduce the water content. The mole ratio of the at least one polyol to the at least one organosilicon compound is greater than about 10:1, preferably between about 12:1 to 30:1, and wherein the mole ratio of the at least one organosilicon compound to the at least one amine is greater than about 1.2:1, preferably between about 2:1 to 20:1. The temperature during the contacting can vary widely, e.g., from about 5° to 40° C. or more. The duration of the contacting will depend upon the initial concentration of water and the desired reduced concentration of water. Often, the contacting is for at least one hour, and in many instances, the organosilicon compound and the amine are formulated in Part A of a two component polyurethane coating system and remain present and active during storage, mixing and coating application and curing. If desired, the formed methanol can be removed by evaporation or stripping.

The source of the water that contaminates the composition is not critical to the broad aspects of the processes of this invention. Usually the water concentration based upon the mass of the polyol ranges between about 1000 and about 30,000 parts per million by mass (ppmw). Although any reduction in the water concentration is beneficial, it is typically desired to reduce the water concentration to less than about 1000 ppmw, and more preferably less than about 500 ppmw.

A yet further broad aspect of this invention pertains to processes for making a polyurethane coating comprising:
a. admixing a polyol-containing composition (Part A) as described above with a polyisocyanate for reacting with the polyol, said admixture further containing catalyst for reacting polyol with polyisocyanate,
b. applying the admixture of step (a) to a surface in the presence of unreacted organosilicon compound and amine from the polyol-containing composition to provide an uncured coating, and
c. curing the uncured coating wherein moisture content of the coating while curing is reduced.

In these processes, at least a portion of the moisture from the environment that passes to the coating during curing is reacted to methanol and thus the curing process and the ultimate cured, polyurethane coating is enhanced.

### DETAILED DISCUSSION

All patents, published patent applications and articles referenced in this detailed description are hereby incorporated by reference in their entireties.

The use of the terms “a” and “an” is intended to include one or more of the element described. Lists of exemplary elements are intended to include combinations of one or more of the element described.

The term “may” as used herein means that the use of the element is optional and is not intended to provide any implication regarding operability.

### Polyurethane Coatings

Polyurethane coatings are prepared from a “two-component” coating composition comprising a Part A comprising a polyol and Part B comprising a polyisocyanate. These components must be stored separately from one another prior to application in order to avoid a premature reaction. Generally Part A and Part B are mixed together shortly before application of the coating. The term “shortly before application” is well-known to a person skilled in the art. The time period within which the coating composition may be prepared prior to actually use or application depends on among other things the pot life of the coating composition. The admixed composition may be applied to a surface in any suitable manner including, but not limited to, spray coating, dipping, by squeegee, brushing or rolling, and casting. Typical coating conditions include ambient temperatures of, say, between about 10° and 40° C., although it is well within the skill of the art to formulate coating compositions that are capable of curing at higher or lower temperatures. If desired, the coating compositions can contain additional curing agents, for instance, for UV curing, to further increase the performance such as chemical resistance and abrasion resistance) of the coating.

The polyols for use in coating compositions of the present invention are preferably polyhydroxy compounds having at least two hydroxyl groups in the molecule and a hydroxyl group content of 3.0 mass percent or more, based on the weight of the polyol compound. In some instances, polyols having lower hydroxyl contents do not provide coatings with sought characteristics. Preferably, the hydroxyl group content in the polyol is 5.0 mass percent or more. The upper limit of the hydroxyl group content is generally 10 or 15 mass percent.

Examples of suitable polyhydroxy compounds include aliphatic hydrocarbon polyols, polyether polyols, polyester polyols, acrylic polyols, epoxypolyols, polycarbonate polyols, and urethane polyols. Each of the above-mentioned polyhydroxy compounds may be used alone or in combination. Among these polyhydroxy compounds, polyester polyols and acrylic polyols which are excellent in weather resistance are preferred. Aliphatic hydrocarbon polyols include, but are not limited to, ethylene glycol; propylene glycol-(1,2) and -(1,3); butylene glycol-(1,4) and -(1,3); hexanediol-(1,6); octanediol-(1,8); neopentyl glycol; cyclohexanedimethanol (1,4-bis-hydroxymethyl-cyclohexane); 2-methyl-1,3-propanediol; 2,2,4-trimethyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

Polyether polyols are often derived obtained by the addition polymerization of alkylene oxides (e.g., ethylene oxide, and propylene oxide or a mixture thereof) with polyhydric alcohols such as described above.

Non-limiting examples of suitable polyester polyols include reaction products of polyhydric, preferably dihydric alcohols to which trihydric alcohols may be added and polybasic, preferably dibasic carboxylic acids. Instead of these polycarboxylic acids, the corresponding carboxylic acid anhydrides or polycarboxylic acid esters of lower alcohols or mixtures thereof may be used for preparing the polyesters. The polycarboxylic acids can be aliphatic, cycloaliphatic, aromatic and/or heterocyclic and they can be substituted, e.g., by halogen atoms, and/or unsaturated. Non-limiting examples of suitable polycarboxylic acids include succinic acid; adipic acid; suberic acid; azelaic acid; sebacic acid; phthalic acid; isophthalic acid; trimellitic acid; phthalic acid anhydride; tetrahydrophthalic acid anhydride; hexahydro-phthalic acid anhydride; tetrachlorophthalic acid anhydride; endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Non-limiting examples of suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; cyclohexanedimethanol (1,4-bis-hydroxymethyl-cyclohexane); 2-methyl-1,3-propanediol; 2,2,4-trimethyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

As used herein, the terms “(meth)acrylic” and “(meth)acrylate” are meant to include both acrylic and methacrylic acid derivatives, such as the corresponding alkyl and alkylol esters often referred to as acrylates and (meth)acrylates, which the term “(meth)acrylate” is meant to encompass. Suitable (meth)acrylic polyols include those prepared by polymerizing suitable hydroxy functional (meth)acrylic esters using known polymerization techniques. Suitable hydroxy functional (meth)acrylic esters include, but are not limited to, hydroxy ethyl(meth)acrylate and hydroxypropyl(meth)acrylate. Additionally, other hydroxy functional polymerizable monomers can be copolymerized with the hydroxy functional (meth)acrylic esters. Non-limiting examples of such hydroxy functional polymerizable monomers include allyl alcohol and glycerol allyl ether.

Polymerizable alkyl and alkylol esters and vinylic monomers can be copolymerized to give a variety of hydroxy functional poly(meth)acrylic resins that can be used as (meth)acrylic polyols in the invention. Suitable (meth)acrylic alkyl esters that can be used include, but are not limited to, methyl(meth)acrylate, ethyl(meth)acrylate, butyl(meth)acrylate and dodecyl(meth)acrylate as well as the hydroxyl functional (meth)acrylates indicated above. Additionally, other vinylic comonomers may be used in preparing the hydroxy functional poly(meth)acrylic resins. These vinylic comonomers include, but are not limited to, styrene, alpha-methyl styrene, cinnamyl esters, diethyl maleate, vinyl acetate, allyl propionate and the like.

Polymeric polyols typically have a number average molecular weight of at least 500 Daltons, in some instances greater than 500 Daltons, in some situations at least 1,000 Daltons, in other situations at least 2,000 Daltons, in certain instances at least 3,000 Daltons, in some cases at least 6,000 Daltons and in other cases at least 8,000 Daltons. Also, the number average molecular weight of the polymeric polyols can be up to 20,000 Daltons, in some cases up to 15,000 Daltons and in other cases up to 12,000 Daltons. The number average molecular weight of the polymeric polyols can vary and range between any of the values recited above.

Acryl polyols include acryl polyol resins obtained by polymerizing (i) one monomer or a mixture of at least 2 monomers selected from the group consisting of acrylates each having active hydrogen atom(s), such as 2-hydroxyethyl acrylate, 2-hydroxypropyl acrylate, and 2-hydroxybuthyl acrylate; methacrylates each having active hydrogen atom(s), such as 2-hydroxyethyl methacrylate, 2-hydroxypropyl methacrylate, and 2-hydroxybuthyl methacrylate; and methacrylic acids and acrylic acids each having polyhydric active hydrogen, such as monoacrylate or monomethacrylate of glycerin, and monoacrylate or monomethacrylate of trimethylolpropane, and (ii) one monomer or a mixture of at least 2 monomers selected from the group consisting of methyl acrylate, ethyl acrylate, isopropyl acrylate, n-butyl acrylate, and 2-ethylhexyl acrylate; and methacrylates such as methyl methacrylate, ethyl methacrylate, isopropyl methacrylate, n-butyl methacrylate, isobutyl methacrylate, and 2-hexyl methacrylate, in the presence or absence of (iii) one monomer or a mixture of at least 2 monomers selected from the group consisting of unsaturated carboxylic acids such as acrylic acid, methacrylic acid and itaconic acid; unsaturated amides such as acrylamide and N-methylol acrylamide; and polymerizable monomers such as styrene, vinyl toluene, vinyl acetate and acrylonitrile.

Epoxy polyols include, but are not limited to, novolaks, βmethylepichlorohydrins, cyclic oxiranes, glycidyl ethers, glycidyl esters, glycol ethers, epoxydized aliphatic unsaturated compounds, epoxydized aliphatic esters, polyvalent carboxylates, aminoglycidyls, and resorcins.

Polycarbonate polyols include, but are not limited to, polycarbonate polyols obtained from aromatic polyhydric alcohols such as bisphenol A, or aliphatic or alicyclic polyhydric alcohols such as 1,6-hexane diol as raw materials.

The coating compositions, according to the invention contain polyisocyanates with free isocyanate groups (Part B) as curing agents. Examples of the polyisocyanates are any number of organic polyisocyanates with aliphatically, cycloaliphatically, araliphatically and/or aromatically bound free isocyanate groups.

Examples of suitable polyisocyanates include aromatic, aliphatic or cycloaliphatic di-, tri- or tetra-isocyanates, including polyisocyanates having isocyanurate structural units, such as, the isocyanurate of hexamethylene diisocyanate and isocyanurate of isophorone diisocyanate; the adduct of 2 molecules of a diisocyanate, such as, hexamethylene diisocyanate and a diol such as, ethylene glycol; uretidiones of hexamethylene diisocyanate; uretidiones of isophorone diisocyanate or isophorone diisocyanate; the adduct of trimethylol propane and meta-tetramethylxylene diisocyanate. Additional examples of suitable polyisocyanates include 1,2-propylene diisocyanate, trimethylene diisocyanate, tetramethylene diisocyanate, 2,3-butylene diisocyanate, hexamethylene diisocyanate, octamethylene diisocyanate, 2,2,4-trimethyl hexamethylene diisocyanate, 2,4,4-trimethyl hexamethylene diisocyanate, dodecamethylene diisocyanate, omega, omega-dipropyl ether diisocyanate, 1,3-cyclopentane diisocyanate, 1,2-cyclohexane diisocyanate, 1,4-cyclohexane diisocyanate, isophorone diisocyanate, 4-methyl-1,3-diisocyanatocyclohexane, trans-vinylidene diisocyanate, dicyclohexylmethane-4,4′-diisocyanate, 3,3′-dimethyl-dicyclohexylmethane-4,4′-diisocyanate, a toluene diisocyanate, 1,3-bis(1-isocyanatol-methylethyl)benzene, 1,4-bis(1-isocyanato-1-methylethyl)benzene, 1,3-bis(isocyanatomethyl)benzene, xylene diisocyanate, 1,5-dimethyl-2,4-bis(isocyanatomethyl)benzene, 1,5-dimethyl-2,4-bis(2-isocyanatoethyl)benzene, 1,3,5-triethyl-2,4-bis(isocyanatomethyl)benzene, 4,4′-diisocyanatodiphenyl, 3,3′-dichloro-4,4′-diisocyanatodiphenyl, 3,3′-diphenyl-4,4′-diisocyanatodiphenyl, 3,3′-dimethoxy-4,4′-diisocyanatodiphenyl, 4,4′-diisocyanatodiphenylmethane, 3,3′-dimethyl-4,4′-diisocyanatodiphenyl methane, a diisocyanatonaphthalene, polyisocyanates having isocyanaurate structural units, the adduct of 2 molecules of a diisocyanate, such as, hexamethylene diisocyanate or isophorone diisocyanate, and a diol such as ethylene glycol, the adduct of 3 molecules of hexamethylene diisocyanate and 1 molecule of water, the adduct of 1 molecule of trimethylol propane and 3 molecules of isophorone diisocyanate, compounds such as 1,3,5-triisocyanato benzene and 2,4,6-triisocyanatotoluene, and the adduct of 1 molecule of pentaerythritol and 4 molecules of toluene diisocyanate. In principle, diisocyanates can be converted by the usual method to higher functional compounds, for example, by trimerization or by reaction with water or polyols, such as, for example, trimethylolpropane or glycerine. The polyisocyanates can also be used in the form of isocyanate-modified resins.

The polyisocyanate cross-linking agents can be used individually or mixed.

The isocyanate groups of polyisocyanate cross-linking agent may be partially blocked. Low molecular weight compounds containing active hydrogen for blocking NCO groups are known. Examples of these are aliphatic or cycloaliphatic alcohols, dialkylaminoalcohols, oximes, lactams, imides, hydroxyalkyl esters, esters of malonic or acetoacetic acid.

The preferred polyisocyanates are liquid at room temperature or become liquid through the addition of organic solvents. At 25° C., the polyisocyanates generally have a viscosity of 1 to 6,000 milliPascal-second (mPas), more preferably, above 5 and below 3,000 mPas. The preferred polyisocyanates are polyisocyanates or polyisocyanate mixtures with exclusively aliphatically and/or cycloaliphatically bound isocyanate groups with an average NCO functionality of 1.5 to 5, preferably 2 to 4. A composition including an aliphatic polyisocyanate may be desirable for applications that require UV stability. However, the present invention is not limited to aliphatic polyisocyanates.

Catalysts are used to catalyze the polymerization of the polyol with the polyisocyanate. The catalyst includes the selected amine catalyst and can further include other amine compounds and organometallic complexes useful as catalysts. Usually, the selected amine catalyst comprises at least about 50, and most preferably, at least about 70, mass percent of the total catalyst component. Specific examples of catalysts include, but are not limited to: tertiary amines such as trmethyl amine, triethyl amine, tripropyl amine, diethylene triamine, N-methyl morpholine, N-ethyl morpholine, diethyl ethanolamine, 1-methyl-4-dimethylamino ethyl piperazine, 3-methoxy-N-dimethyl propyl amine, N-dimethyl-N′-methyl isopropyl propylene diamine, N,N-diethyl-3-diethyl amino propyl amine, N,N-dimethyl benzyl amine, dicyclohexylmethylamine, 2,4,6-tris dimethylaminomethylphenol, N,N-dimethyl cyclohexylamine, trimethylamine, tri-n-butylamine, 1,8-diaza-bichloro[5,4,0]-undecene-7, N-methyl diethanolamine, N,N-dimethyl ethanolamine, N,N-dimethyl cyclohexylamine, N,N,N′N′-tetramethyl-ethylene diamine, 1,4-diaza-bicyclo-[2,2,2]-octane, N-methyl-N′-dimethylaminoethyl-piperazine, bis-(N,N-diethylaminoethyl)-adipate, N,N-diethylbenzylamine, pentamethyldiethylene triamine, N,N,N′,N′-tetramethyl-1,3-butanediamine, 1,2-dimethylimidazole, 2-methylimidazole: tin compounds such as stannous chloride, dibutyltin di-2-ethyl hexoate, stannous octoate, 2-ethylhexoic acid stannous octoate, dibutyl tin dilaurate, trimethyl tin hydroxide, dimethyl tin dichloride, dibutyl tin diacetate, dibutyl tin oxide, tributyl tin acetate, tetramethyl tin, dimethyl dioctyl tin, tin ethyl hexoate, tin laurate, dibutyl tin maleate, and dioctyl tin diacetate; zinc octoate; phenyl mercuric propionate, lead octoate; lead naphthenate, copper naphthenate, titanium ethylacetoacetate complex, and titanium, bis(ethyl-3-oxobutanoato) bis(2-metyl-1propanolato) complex. When used, the preferred amount of catalyst is about 0.005 to 0.5 mass percent based upon the total mass of polyol and polyisocyanate.

In some instances, an inhibitor may be used to increase pot life. Examples of inhibitors are organic and inorganic acids, such as benzoyl chloride, p-toluene sulfonic acid, formic acid, acetic acid, benzoic acid, phosphoric acid, hydrochloric acid, and the like. When used, the preferred amount of inhibitor is between about 0.01 and 1 mass percent based upon the total mass of polyol and polyisocyanate.

Defoamers are used to modify the characteristics of polyurethane composition by eliminating process defects like entrapped bubbles and surface defects such as pin holes and orange peelmarks, acting as air release and anti-foaming agents. Chain extenders are low molecular weight hydroxyl and amine terminated compounds that play an important role in the polymer morphology of polyurethane chains.

Suitable solvents include hydrocarbons such as cyclohexane, mineral sprit, and naphtha; ketones such as acetone, methyl ethyl ketone and methyl isobutyl ketone; and esters such as ethyl acetate, n-butyl acetate, isobutyl acetate, cellosolve acetate, and propylene glycol monomethylether acetate, in accordance with an end use. Each of these solvents may be used alone or in combination with at least one selected from the above. Preferably, the solvent component is an ester such as ethyl acetate, n-butyl acetate, isobutyl acetate, cellosolve acetate, and propylene glycol monomethylether acetate, or a ketone such as methyl ethyl ketone, and methyl isobutyl ketone. The amount of solvent used will usually depend upon the method for application of the coating composition and the viscosity of the composition in the absence of a solvent. When used, the solvent is generally present in an amount of between about 1 and 50 mass percent based upon the total mass of polyol and polyisocyanate.

Part A and Part B are usually present in an amount sufficient to provide a ratio of isocyanate groups to hydroxyl groups of at least 0.8:1, preferably at least about 0.9:1, and more preferably at least about 0.95:1 up to about 1.2:1, preferably up to about 1.1:1. In some instances the ratio is between about 0.95:1 to 1.05:1.

### Moisture Removal

In accordance with this invention, Part A of the polyurethane coating system contains at least one organosilicon compound as set forth above and at least one amine as set forth above. Conveniently, the organosilicon compound in the amine can be introduced into the composition of Part A at the time of manufacture of Part A, or alternatively, one or both of the organosilicon compound and amine can be added to Part A prior to its use with the polyisocyanate-containing Part B to form the polyurethane composition. In any event, the contact time of both of the organosilicon compound and amine with Part A is sufficient to provide a sought reduction in moisture prior to admixture with Part B. Although the duration of the contact will depend upon the concentration of water in Part A, the sought reduction of moisture, and the nature of the organosilicon compound and amine, usually sufficient moisture reduction is achieved in less than 30 hours, and in some times between about 1 and 24 hours.

Surprisingly the transalkylation of the organosilicon compound with water can be effected at ambient temperatures, e.g., between about 5° and 40° C., by using certain amine catalysts. Moreover, as the organosilicon compound is converted to a silanol, which can react with another silanol to form a condensation product, a siloxane, with the elimination of water. The formation of siloxane in significant amounts has not been observed. Without wishing to be limited by theory, it is believed that the transalkylation of the organosilicon compound with water is a reversible reaction and the combination of the selection of the organosilicon compound and amine may serve to protect the silanol from condensation reactions under these conditions.

Preferably the organosilicon compound and the amine are soluble in the composition of Part A. If necessary, sufficient solvent can be added to Part A to assure the solution of the organosilicon compound and amine in the composition.

An organosilicon compound is used in accordance with this invention. The preferred organosilicon compounds are those having at least 2, and preferably 3, methoxy substituents on the silica and atom. The organosilicon compound has at least one hydrocarbon-based electron withdrawing moiety on the silica atom. Generally, this hydrocarbon-based electron withdrawing moiety provides a withdrawing strength at least equivalent to that of a phenyl group. As stated above, the most preferred hydrocarbon-based electron withdrawing moieties are vinyl groups. Examples of organosilicon compounds include, but are not limited to, vinyl trimethoxysilane, divinyl dimethoxysilane, vinyl methyl dimethoxysilane, vinyl dimethyl methoxysilane, phenyl trimethoxysilane, diphenyl dimethoxysilane, phenyl methyldimethoxysilane, 3,5-bis[trimethoxysilyl]phenol, 4-trimethoxysilylphenol, methoxyethyl trimethoxysilane, fluoroethyl trimethoxysilane, perchloroethyl trimethoxysilane, perchloromethyl trimethoxysilane, perchloromethyl methyl dimethoxysilane, 3-propenyl trimethoxysilane, and 3-propenyl methyldimethoxysilane.

The amine may be monofunctional, difunctional or polyfunctional. Preferably the amine is difunctional or polyfunctional. Each dimethylamino group on the amine is bonded to a hydrocarbon group which, is substituted, is substituted on the beta atom or subsequent atom. While not wishing to be limited to theory, it is believed that this hydrocarbyl linkage not only answer hydrophobicity to the amine, but also, it shelters the electron residence at the amine site for purposes of the catalytic activity. In the preferred amines, the beta atom or subsequent atom is substituted with a moiety that has greater affinity for water than does the hydrocarbyl group. Such moieties include, but are not limited to, keto, ether, amine (tertiary and preferably secondary amine), urea, ester, hydroxy and halo, preferably fluoro or chloro. One class of preferred amines contains difunctional and polyfunctional amines that contain one or more urea groups.

Examples of amines include, but are not limited to, dimethyl propyl amine, dimethyl butyl amine, dimethyl hexyl amine, dimethyl cyclohexyl amine, methoxyethyl dimethylamine, ethoxyethyl dimethylamine, methoxy propyl dimethylamine, bis-[(3-dimethylamino) propyl] ether, bis-[(3-dimethylamino) propyl] amine, bis-[(3-dimethylamino) propyl] ketone, bis-[(3-dimethylamino) propyl] urea, bis-[(2-dimethylamino) ethyl] urea, bis-[(2-dimethylamino) ethyl] ketone, bis-[(2-dimethylamino) ethyl] ether, bis-[(2-dimethylamino) ethyl] amine, bis-[(4-dimethylamino) butyl] urea, bis-[(4-dimethylamino) butyl] ketone, bis-[(4-dimethylamino) butyl] ether, dimethylaminobenzene, 4-dimethylaminophenol, 1,4-bis-(dimethylamino)benzene, 1,3,5-tris-(dimethylamino)benzene, dimethylamino methyl benzene, dimethylamino methyl phenol, dimethylamino ethyl benzene, 1,4-bis-[dimethylamino methyl] benzene, 1,4-bis-[dimethylamino ethyl] benzene, 1,4-bis-[3-dimethylamino propyl] benzene, 3,5-bis-[dimethylamino propyl] benzene, 1,4-bis-[dimethylamino methyl] phenol, 2,4,6 tris-[dimethylamino methyl] phenol, 2,4,6 tris-[dimethylamino ethyl] phenol, and 2,4,6 tris-[3-dimethylamino propyl] phenol.

1. A polyol-containing compositions for making polyurethane coatings comprising:
a. at least one polyol;
b. at least one organosilicon compound represented by the formula
(R¹)₍₄₋ₙ₎—Si—(OCH₃)ₙ
wherein n is an integer of 1 or 2 or 3 and each R¹ is selected from the group of (i) substituted or unsubstituted aliphatic or aromatic hydrocarbyl of 1 to about 6 carbons wherein the substituents are alkoxy of 1 to 4 carbons, hydroxy and halo and (ii) alkoxy of 1 to 4 carbons with the proviso that at least one R¹ is an electron withdrawing moiety selected from the group consisting of (R²)₍₃₋ₘ₎Xₘ—C—C(H₂)— wherein R² is hydrogen or alkyl of 1 to 4 carbons, X is hydroxyl, fluorine or chlorine and m is an integer of 1, 2 or 3; (R²)₍₂₋ₚ₎Xₚ—C═C(H)— and p is an integer of zero, 1 or 2; and phenyl and substituted phenyl wherein the substituents are alkyl, hydroxy or alkoxy of 1 to 4 carbons and halo; and
c. at least one amine represented by the formula
(H₃C)₂—N—R³ or [(H₃C)₂—N]_{(q)}R⁴ or [(H₃C)₂—N—C(H₂)—C(H₂)]_{(q)}—R⁵
wherein R³ is alkyl of 3 to 6 carbons which other than the alpha carbon can be substituted or unsubstituted wherein the substituents are aromatic hydrocarbyl; alkoxy; hydroxyl; halo; carboxy; and carbamyl moieties, and R⁴ is an unsubstituted or substituted hydrocarbyl of 2 to 24 carbons or heteroaliphatic or heteroaromatic, wherein the hetero atom is one or more of oxygen, sulfur, nitrogen, wherein the amine is at least two carbons distant from any electron withdrawing group, and q is an integer from 2 to 6; wherein R⁵ is selected from the group of alkylene of 1 to about 8 carbons; —(R⁶)₂—(C(O)) wherein R⁶ is hydrogen or an alkylene of 1 to 4 carbons; and —(R⁶N(H))₂—(C(O)) wherein R⁶ is hydrogen or an alkylene of 1 to 4 carbons,
wherein the mole ratio of the at least one polyol to the at least one organosilicon compound is greater than about 10:1, and wherein the mole ratio of the at least one organosilicon compound to the at least one amine is greater than about 1.2:1.

2. The composition of claim 1 further comprising a catalyst for the reaction between the polyol and a polyisocyanate.

3. The composition of claim 1 further comprising at least one adjuvant.

4. The composition of claim 1 wherein at least one R¹ of the organosilicon compound is a vinyl group.

5. The composition of claim 4 wherein the organosilicon compound is a trimethoxysilane.

6. The composition of claim 1 wherein the amine catalyst is represented by the formula
[(H₃C)₂—N]_{(q)}R⁴
where q is an integer of 1, 2, 3 or 4 and R⁴ is an alkane or —(R⁷)_{(q)}—R⁸ wherein R⁷ is alkylene of 1 to 4 carbons and R⁸ is phenyl or alkene.

7. The composition of claim 6 wherein in the amine catalyst is
[(H₃C)₂—N—C(H₂)—C(H₂)]_{(q)}—R⁵
where q is an integer of 1, 2, 3 or 4 and R⁵ is (R⁶N(H))ᵣ—(C(O)) wherein R⁶ is hydrogen or an alkylene of 1 to 4 carbons.

8. The composition of claim 7 wherein the amine catalyst is 1,3-bis[3-dimethylanimo)propyl]urea.

9. The composition of claim 7 wherein at least one R¹ of the organosilicon compound is a vinyl group.

10. The composition of claim 4 wherein the organosilicon compound is a trimethoxysilane.

11. A process for reducing the moisture content of polyol-containing compositions comprising contacting a moisture-containing polyol composition with an organosilicon compound represented by the formula
(R¹)₍₄₋ₙ₎—Si—(OCH₃)ₙ
wherein n is an integer of 1 or 2 or 3 and each R¹ is selected from the group of (i) substituted or unsubstituted aliphatic or aromatic hydrocarbyl of 1 to about 6 carbons wherein the substituents are alkoxy of 1 to 4 carbons, hydroxy and halo and (ii) alkoxy of 1 to 4 carbons with the proviso that at least one R¹ is an electron withdrawing moiety selected from the group consisting of (R²)₍₃₋ₘ₎Xₘ—C—C(H₂)— wherein R² is hydrogen or alkyl of 1 to 4 carbons, X is hydroxyl, fluorine or chlorine and m is an integer of 1, 2 or 3; (R²)₍₂₋ₚ₎Xₚ—C═C(H)— and p is an integer of zero, 1 or 2; and phenyl and substituted phenyl wherein the substituents are alkyl or alkoxy of 1 to 4 carbons, hydroxy and halo; and
at least one amine represented by the formula
(H₃C)₂—N—R³ or [(H₃C)₂—N]_{(q)}R⁴ or [(H₃C)₂—N—C(H₂)—C(H₂)]_{(q)}—R⁵
wherein R³ is alkyl of 3 to 6 carbons which other than the alpha carbon can be substituted or unsubstituted wherein the substituents are aromatic hydrocarbyl; alkoxy; hydroxyl; halo; carboxy; and carbamyl moieties, and R⁴ is an unsubstituted or substituted hydrocarbyl of 2 to 24 carbons or heteroaliphatic or heteroaromatic, wherein the hetero atom is one or more of oxygen, sulfur, nitrogen, wherein the amine is at least two carbons distant from any electron withdrawing group, and q is an integer from 2 to 6, wherein R⁵ is selected from the group of alkylene of 1 to about 8 carbons; —(R⁶)₂—(C(O)) wherein R⁶ is hydrogen or an alkylene of 1 to 4 carbons; and —(R⁶N(H))₂—(C(O)) wherein R⁶ is hydrogen or an alkylene of 1 to 4 carbons
wherein the mole ratio of the at least one polyol to the at least one organosilicon compound is greater than about 10:1, and wherein the mole ratio of the at least one organosilicon compound to the at least one amine is greater than about 1.2:1, for a time sufficient to reduce the water content.

12. The process of claim 11 wherein the contacting is at temperature of between about 5° to 40° C.

13. The process of claim 12 wherein the contacting is for at least one hour.

14. The process of claim 13 wherein the organosilicon compound and the amine are formulated in Part A of a two component polyurethane coating system and remain present and active during storage, mixing and coating application and curing.

15. The process of claim 11 wherein methanol is removed.

16. The process of claim 11 wherein the water concentration based upon the mass of polyol is reduced to less than 1000 ppmw.

17. A process for making a polyurethane coating comprising:
a. admixing a polyol-containing composition of claim 1 with a polyisocyanate for reacting with the polyol, said admixture further containing catalyst for reacting polyol with polyisocyanate,
b. applying the admixture of step (a) to a surface in the presence of unreacted organosilicon compound and amine from the polyol-containing composition to provide an uncured coating, and
c. curing the uncured coating wherein moisture content of the coating while curing is reduced.

18. The process of claim 17 wherein the polyol-containing composition further contains catalyst for the reaction between the polyol and a polyisocyanate.

19. The process of claim 17 wherein at least one R¹ of the organosilicon compound is a vinyl group.

20. The process of claim 19 wherein the organosilicon compound is a trimethoxysilane.

21. The process of claim 19 wherein the amine catalyst is represented by the formula
[(H₃C)₂—N]_{(q)}R⁴
where q is an integer of 1, 2, 3 or 4 and R⁴ is an alkane or —(R⁷)_{(q)}—R⁸ wherein R⁷ is alkylene of 1 to 4 carbons and R⁸ is phenyl or alkene.

22. The process of claim 21 wherein in the amine catalyst is
[(H₃C)₂—N—C(H₂)—C(H₂)]_{(q)}—R⁵
where q is an integer of 1, 2, 3 or 4 and R⁵ is (R⁶N(H))ᵣ—(C(O)) wherein R⁶ is hydrogen or an alkylene of 1 to 4 carbons.

23. The process of claim 22 wherein the amine catalyst is 1,3-bis[3-dimethylanimo)propyl]urea.

24. The process of claim 23 wherein the cured coating is clear.
